(19) United States
(12) Patent Application Publication
(10) Pub. No.: US 2025/0371108 A1
(43) Pub. Date: Dec. 4, 2025

(54) DISTRIBUTED DATA OBJECT CLASSIFICATION

(71) Applicant: Intel Corporation, Santa Clara, CA (US)

(72) Inventors: Omer BEN-SHALOM, Rischon LeZion (IL); Dan HOROVITZ, Rishon LeZion (IL); Yaron KLEIN, Rosh Haayin (IL)

(21) Appl. No.: 19/299,389

(22) Filed: Aug. 14, 2025

(51) Int. Cl. G06F 18/2413; G06N 20/00

(52) U.S. Cl. CPC G06F 18/2413; G06N 20/00

(57) ABSTRACT

Various aspects relate to mechanisms for data object classification in connection with a memory and a processor. At an endpoint device, a classification of a data object is determined based on output from a machine learning model configured to take as input contents and metadata of the data object, wherein the classification comprises a confidence score. It is determined whether the data object requires additional review, based on the confidence score. A data object hash is computed based on the contents and the metadata of the data object. An internal structure of the machine learning model is updated based on the additional review, the data object hash, and subsequent operation of the endpoint device.

### BACKGROUND

Data protection tools such as data loss protection, data security posture management, data detection and response typically depend on proper classification of structured as well as non-structured content. Document classification typically involves understanding types of content, content ownership, security classification, and sensitivity. Conventional data classification and tagging is most effective with respect to narrow knowledge domains such as financial data, health data, and to some degree privacy related data, such as use cases related to European general data protection regulation. For general intellectual property content that is common within enterprises conventional classification systems are ineffective at classifying data due to the fact that such content typically does not lend itself well to regular expression or similar matching and to the fact that some of the critical elements like sensitivity change over time, for example, when such information is publicly disclosed at a conference, thereby becoming non-confidential and much less important to protect.

Modern alternatives use large language models and various classifiers but building and training such models is a challenge for various reasons. In some cases, enterprises do not want to share their intellectual property for the purpose of artificial intelligence model training. Learning from files “at rest” does not include much of the critical information related to the intellectual property such as the identity of the creators and/or contributors to the intellectual property content. Some ineffective conventional technologies include regular expression matching techniques, which are based on pattern matching of content within a document as well as manual classification in which a user selects specific documents to be classified in a certain way.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the proposed configuration. In the following description, various aspects are described with reference to the following drawings, in which:

FIG. 1 shows an exemplary high-level system architecture diagram consistent with various aspects;

FIG. 2 shows an exemplary endpoint artificial intelligence classification flow diagram consistent with various aspects;

FIG. 3 shows an exemplary centralized metadata analytics and feedback loop flow diagram consistent with various aspects;

FIG. 4 shows another exemplary system architecture diagram consistent with various aspects; and

FIG. 5 shows another exemplary system architecture diagram consistent with various aspects including centralized policy updates as well as platform operator updates.

### DESCRIPTION

The following detailed description refers to the accompanying drawings that show, by way of illustration, specific details and aspects in which the proposed configuration may be practiced. These aspects are described in sufficient detail to enable those skilled in the art to practice the proposed configuration. Other aspects may be utilized and structural, logical, and electrical changes may be made without departing from the scope of the proposed configuration. The various aspects are not necessarily mutually exclusive, as some aspects may be combined with one or more other aspects to form new aspects. Various aspects are described in connection with methods and various aspects are described in connection with devices (e.g., a memory module, a computing system). However, it is understood that aspects described in connection with methods may apply in a corresponding manner to the devices, and vice versa.

Artificial intelligence techniques in the context of data object classification may involve behavioral analysis. In various aspects, data loss protection mechanisms employ machine learning to analyze user behavior and detect anomalies that may indicate data breaches or insider threats. Automated classification as described herein involves artificial intelligence-driven data loss protection systems, which can automatically classify data based on content, improving accuracy and reducing manual effort.

Use of such techniques requires building models based on actual enterprise information, including intellectual property, as interacting with simulated data may be insufficient to generate beneficial enhancements consistent with the mechanisms described herein. User interaction with enterprise information results in identification of relationships between data object metadata and accurate classifications that were not identified by generally trained machine learning models. The newly identified relationships may be used on local endpoint computing devices to update the structure of locally used machine learning models for classification, so that ongoing training and reinforcement of a local machine learning model is accomplished in connection with ongoing use of the endpoint computing device.

Endpoint data loss protection can be important so that users of endpoint computing devices may safely interact with enterprise information without putting such information at risk. Comprehensive endpoint coverage is important to ensure that important enterprise information does not inadvertently (or otherwise) leak from an endpoint. Data loss protection solutions are expanding to cover a wide range of endpoints, including mobile devices, laptops, and internet of things devices, ensuring data protection across a variety of user devices. Real-time monitoring of endpoint devices has a benefit of ensuring that up-to-date policies can be enforced on an endpoint computing device while enterprise information is in use. Endpoint data loss protection provides real-time monitoring and response capabilities to prevent data loss at the device level. Some vendors offer data loss protection as part of a broader unified security suite, integrating with other security tools like firewalls, intrusion detection systems, and identity management solutions.

Advanced encryption and tokenization enjoy the benefit of incorporating advanced encryption techniques to protect data both at rest and in transit. Tokenization may be used to replace sensitive data with non-sensitive equivalents, reducing the risk of exposure. User and entity behavior analytics help identify potential insider threats by analyzing patterns and behaviors that deviate from normal and expected behaviors and activities. Data loss protection systems in various aspects may assign risk scores to users and entities based on their behavior, helping prioritize security responses. Granular policy-based technologies offer granular policy management, allowing organizations to define specific rules for different types of data and user roles. Automated enforcement of policies ensures consistent application across all data channels and user activities.

Comprehensive data discovery and classification mechanisms provide tools for discovering sensitive data across an organization, including structured and unstructured data sources. Dynamic classification capabilities allow data loss protection systems to adapt to changing data environments and automatically update classifications. Enterprise information entities (data objects or files) may have classification-relevant metadata based on a business process to which a data object is related and other metadata aspects associated with the data object. Traditional mechanisms for training classification models would involve collecting all such elements and uploading them for training resulting in huge increase in volume and training complexity as well as potentially exposing critical enterprise information to a training environment.

Various aspects provide a distributed, artificial-intelligence-driven file classification system designed specifically for enterprise environments. It operates by running lightweight artificial intelligence classification modules directly on endpoint devices, enabling local analysis of file content, metadata, and user interactions without transmitting this sensitive data externally. Anonymized metadata from endpoints is centrally aggregated and analyzed to generate organizational insights, refine classification policies, and ensure compliance, resulting in a highly accurate, scalable, and privacy-preserving solution.

In various aspects, each endpoint computing device within an enterprise employs artificial intelligence for machine learning and machine learning model enhancement. In various aspects, the disclosed data object classification systems track file creation, access and collaboration. With such data, the disclosed data object classification systems aggregate insights (metadata) to a centralized engine. Disclosed data object classification systems use artificial-intelligence-based file classification by employing artificial intelligence compute collaboration, running on endpoints that iteratively update local machine learning models of the endpoints, based on actual enterprise data. Derived insights regarding improvements to a structure of an associated machine learning model may then be shared to a server for cross-reference with metadata from other endpoints.

Specific enterprise content is not shared with centralized server-only metadata. Supervised learning is performed in connection with user access and/or usage based on user interaction with data objects from multiple systems (e.g., cloud-based data object storage platforms, group-based user communication systems and office productivity software). The herein-described data object classification systems enjoy benefits of being more accurate and more efficient. The systems employ edge compute artificial intelligence enabled personal computing devices for training and inference. This enables data object labeling to scale in connection with enterprise information, including distributed data. Organization-level fine tuning is achieved based on business needs and usages of an organization, while preserving privacy.

The herein-described data object classification systems provide distributed, artificial-intelligence-driven systems for the automated and accurate classification of enterprise data and files across organizational endpoints. The classification process leverages local artificial intelligence processing (edge computing) capabilities on each endpoint to classify files based on content, metadata, user interactions, and context. The endpoints do not send raw file data to a central server; instead, they only send metadata summaries, classification outcomes, and contextual information, thus preserving privacy and reducing data exposure risks.

Local artificial intelligence mechanisms are operated and enhanced at each endpoint. Each endpoint (e.g., employee laptops, desktops, servers, or mobile devices) runs a lightweight artificial intelligence inference module optimized for local processing (edge computing). A local artificial intelligence machine learning model continuously monitors file-related events (creation, modification, access, sharing, and user interactions) as well as events associated with content processing applications like PowerPoint, Excel, Word using associated plugins or addons, for example. Endpoint artificial intelligence mechanisms classify data objects, such as files into predefined categories based on multiple local data dimensions. In various aspects, natural language processing and deep learning models analyze file contents locally, identifying sensitive keywords, context, and semantic meaning and visual analysis of images.

Various factors are relevant with respect to classification of data objects. Such factors include the type of data object, i.e., E-mail, text file, or spreadsheet. Other factors include the visual appearance of a data object, including color, image density and contrast, font size, etc. Other factors include the original author, editor, owner, or maintainer of a particular data object as well as the business purpose of a data object. Content movement and/or creation events are relevant as well. When new content is added to a document, by copy and paste, insert, any changes in the original document with respect to a current or previous version of a data object. That is to say that any difference in a data object (and its associated metadata) that is subject to modification may be relevant to a classification of the data object.

Usage of similar sections and/or paragraphs within multiple data objects may serve to provide insights with respect to data object similarity and an actual context of some or all of the content of a data object. Similar insights may be gleaned from file metadata analysis. File type, creator, creation/modification timestamps, file size, and file location may be significant. User interaction patterns provide further classification-relevant information. Frequency of access, collaboration activities (such as sharing or co-editing), and ownership attributes. Business context integration may be significant as well. Integration with enterprise productivity tools and data sources, i.e., cloud-based storage, collaboration, messaging, and office productivity solutions, may provide additional contextual metadata to enhance classification accuracy.

In various aspects, only privacy-preserving metadata may be transmitted to a centralized repository. Raw file data content does not leave the endpoint. Instead, each endpoint transmits only anonymized or obfuscated metadata and classification outcomes to the centralized server. Such metadata may include file classification category and confidence scores, file hashes and incremental changes (hash-deltas) for integrity attestation. A hash delta is a difference between a current hash of a data record and a previously stored hash of a same or similar record. Delta hashing allows systems, in various aspects, to efficiently identify and process only changed data rather than reprocessing an entire dataset, thereby more efficiently utilizing computing resources. User interaction statistics may be provided without personal user identifiers, for privacy compliance. Contextual data points, e.g., business unit, department-level identifiers, file storage locations may be obfuscated as well. Such a use of hash-deltas to enhance a machine learning model for document classification reflects an improvement in the functioning of a computer as compared to state-of-the-art artificial intelligence-based document classification systems. The technical solution of application of delta hashes to metadata associated with user interactions with data objections provides a technical solution to the technical problem of improving the functioning of artificial intelligence-based automated document classification.

In various aspects, metadata associated with data objects may be centrally aggregated and analyzed. A central server may collect and aggregate metadata from multiple endpoints across an organization. In so doing, a central server generates a physical electrical signal which signal the central server transmits to a plurality of endpoints to instruct the endpoints to produce a responsive signal containing information regarding changes to one or more machine learning models associated with the endpoints. A centralized engine applies advanced analytics and artificial intelligence models on the aggregated metadata to generate organization-wide insights on data classification patterns and trends. Misclassifications or false positives/negatives may then be identified based on metadata consistency analysis and historical patterns. Classification policy adjustments may be recommended based on observed organizational behavior and document usage patterns. This centrally developed corpus of enterprise information may be used to support audit trails, compliance reporting, and security monitoring through metadata-driven analytics and dashboards.

In various aspects, continuous improvement and false-positive classification reduction may be provided in the form of a supervised feedback loop. Automatic data object classification systems consistent with various aspects may incorporate supervised learning at an endpoint level, allowing users and administrators to identify misclassifications. Endpoint modules may then use such manual inputs as feedback for incremental training adjustments. Centralized aggregation of these feedback signals enables continuous improvement of the enterprise model and adaptive policy updates.

In various aspects, data and code integrity attestation may be provided by way of cryptographic hashing (e.g., SHA-256) of files and incremental hash-deltas performed on endpoints to provide integrity verification without content exposure. In various aspects, a centralized server maintains attestation logs based on endpoint-provided metadata hashes, enabling compliance, auditing, and forensic analysis capabilities.

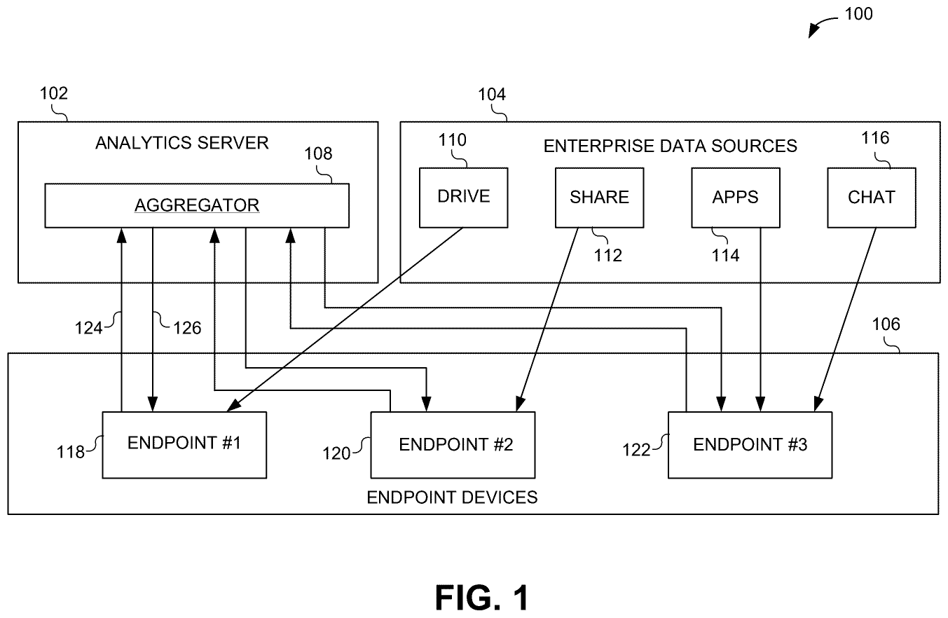

FIG. 1 shows an exemplary high-level system architecture diagram 100 consistent with various aspects. Diagram 100 illustrates an overall architecture of the distributed artificial-intelligence-based file classification system 106, highlighting endpoint devices 118, 120, and 122 performing local artificial-intelligence data object (file) classification independently. Endpoints 118, 120, and 122 analyze files locally and transmit only anonymized metadata (without sensitive data) to a centralized analytics server 102 employing an aggregator 108, which transmits and receives anonymized metadata from various endpoints 118, 120, and 122 via exemplary transmission links 124 and 126. Analytics server 102 aggregates metadata, generates insights, and provides updated policies back to endpoints 118, 120, and 122 to enhance classification accuracy.

In various aspects, enterprise data sources 104 may be provided, such as, for example, organizational productivity software, document and/or presentation composition tools or communications tools such as e-mail or organizational chat platforms. Drive 110 may be a cloud-based storage service that allows users to store, access, and share files across multiple devices. Share 112 may be a web-based platform that enables organizations to store, organize, share, and access information for document management and collaboration. Apps 114 may include office productivity software such as spreadsheets, email user interfaces, and word processors. Chat 116 may include one or more cloud-based unified communication and collaboration platforms, such as a group-based communication platform that provides features such as instant messaging, video conferencing and file sharing.

Enterprise data sources may be provided in connection with information protection indicia. Information protection indicial may include information protection labels used to classify and protect sensitive data within an organization. Such information protection indicia may help users understand the sensitivity of information and aid compliance officers and administrators in identifying where sensitive data resides. Information protection labels may be applied manually or automatically based on various of the techniques disclosed herein. Information protection indicia consistent with various aspects may classify and protect data. Such classifications may include “confidential,” “highly confidential,” “general” or even “public” such that, for example, there would significant restrictions on confidential or highly confidential information with much lower restrictions on public information. However, it is understood that even the context of possessing certain publicly available information may reveal proprietary information that may be of value to an organization.

Information protection indicia may be used to control access to certain data objects. In connection with properly secured endpoint computing devices and corresponding restricted-access organizational productivity software, information protection indicia may restrict which users within an organization can access, modify, or share sensitive information. In the context of sharing confidential information, such access controls may prevent a user from transmitting a labeled data object outside of the organization or even limit dissemination to specific users within the organization. Information protection indicial may mark content by adding watermarks, headers, footers, or the like to data objects such as files or emails, visually indicating the sensitivity of the relevant data objects. Moreover, information protection labels may extend protections over multiple platforms. In various aspects, the information protection indicia may be affixed to data objects of various types e.g., composed electronic documents, emails, and/or presentations in connection with various platforms, such as personal various computing device operating systems and/or mobile device operating systems. That is to say a document composed with Microsoft Office productivity tools that were transferred to a mobile device using the Android mobile operating system could benefit from a consistent security treatment according to a corresponding document classification and information protection label.

By classifying and controlling access to sensitive information, information protection labels help prevent data breaches and unauthorized access by facilitating improved compliance. Labels help organizations meet regulatory requirements and internal policies related to data protection and can facilitate increased user awareness. Labels may help educate users about the sensitivity of the information they are handling. Labels may provide simplified data governance by providing tools for discovering, classifying, and managing sensitive data across an organization. In essence, information protection labels are a crucial part of a comprehensive data protection strategy, helping organizations safeguard their sensitive information and comply with relevant regulations.

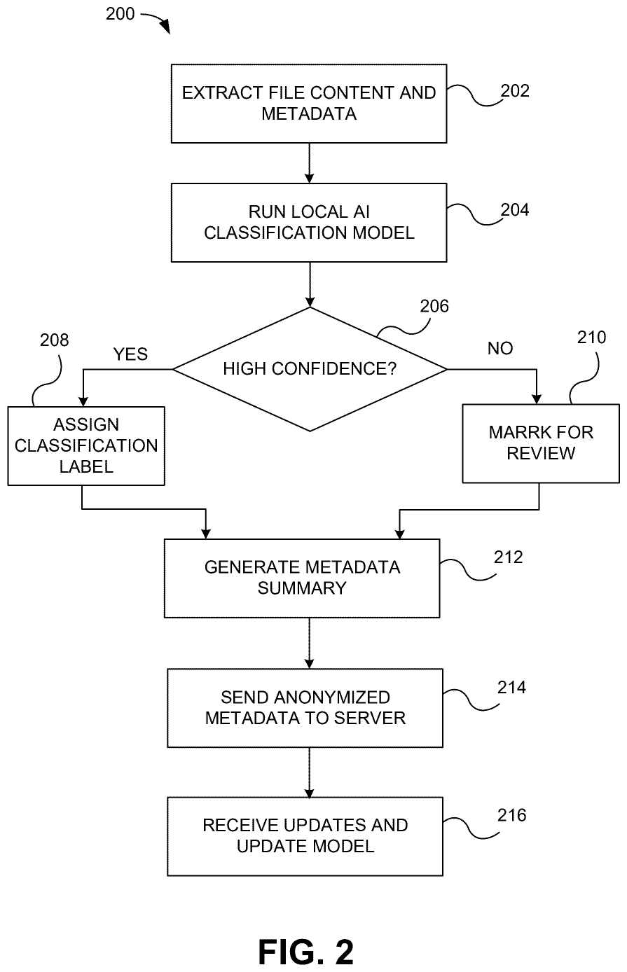

FIG. 2 shows an exemplary endpoint artificial intelligence classification flow diagram 200 consistent with various aspects. Flow diagram 200 describes a detailed file classification process performed locally on each endpoint. In some aspects, file access, creation or modification may cause the process to be initiated. Data object organization may also trigger the process, such as when a group of data objects are associated with each other for example in a file system or a folder within a file system or other data store. At stage 202, content and metadata are extracted from data objects that have been identified as relevant to a potential data object classification.

Next, at stage 204, one or more data objects may be classified using one or more local artificial intelligence models. In various aspects, local endpoint machine learning models are based on an initial generic machine learning model that has been trained on generic enterprise data. However, over time, each individual endpoint machine learning model identifies additional features and/or metadata that are associated with various specific data objects that an endpoint user interacts with in connection with a particular endpoint.

Once, at stage 204, an artificial intelligence classification model has produced a candidate classification for a particular data object, it is determined at test 206 whether the classification is made with a sufficiently high confidence. A confidence level associated with a machine learning model classification may be associated with a confidence score that is derived from an output layer of a neural network. In some aspects, this entails applying an activation function to raw outputs of the neural network to produce a probability of correct classification. If it is determined at test 206 that the classification is made with high confidence, at stage 208, an associated classification label is assigned to the classified data object. If, on the other hand, is determined at test 206 that the classification is not made with high confidence, at stage 210, the classified data object is marked for further review, either by a human or an external artificial intelligence system, for example.

In either case after either of stages 208 and 210, flow continues to stage 212 at which point a metadata summary entry is generated that is associated with the classification, and any review that was made in connection with a non-high confidence classification. The generated metadata is anonymized so as not to identify either a user of an endpoint system or any personally or organizationally identifiable information associated either with the user of the endpoint or of the endpoint itself. Similarly, any substantive information associated with content of the classified data object is obfuscated to preserve confidentiality of any associated enterprise information contained within the classified data object. Next, at stage 214, the endpoint then securely sends anonymized metadata and file hashes to a central server. Finally, at stage 216, the endpoint receives policy updates and insights back, and updates its local policies accordingly.

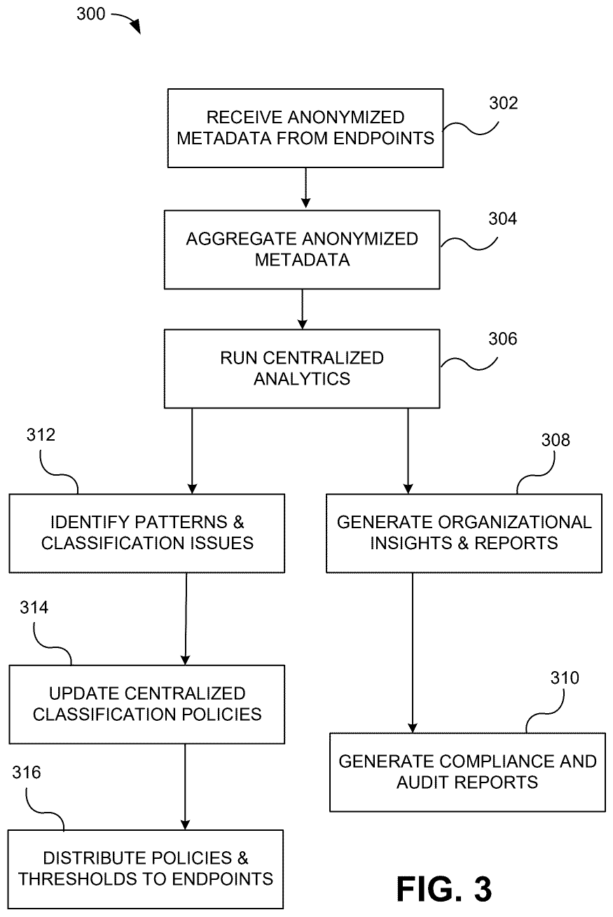

FIG. 3 shows an exemplary centralized metadata analytics and feedback loop flow diagram 300 consistent with various aspects. Feedback loop flow diagram 300 illustrates how anonymized metadata from multiple endpoints flows upward into a centralized storage. At stage 302, a central system receives anonymized metadata from endpoints. Next, at stage 304 the central system aggregates and correlates the metadata. Next at stage 306, the central system runs analytics to identify patterns, classification issues, and organizational insights.

At stage 308, organizational insights and reports are generated. At stage 310 compliance and audit reports are generated. At stage 312, patterns and classification issues are identified. At stage 312, centralized classification policies are updated. At stage 316, policies and thresholds are distributed downward to endpoints to continuously improve accuracy.

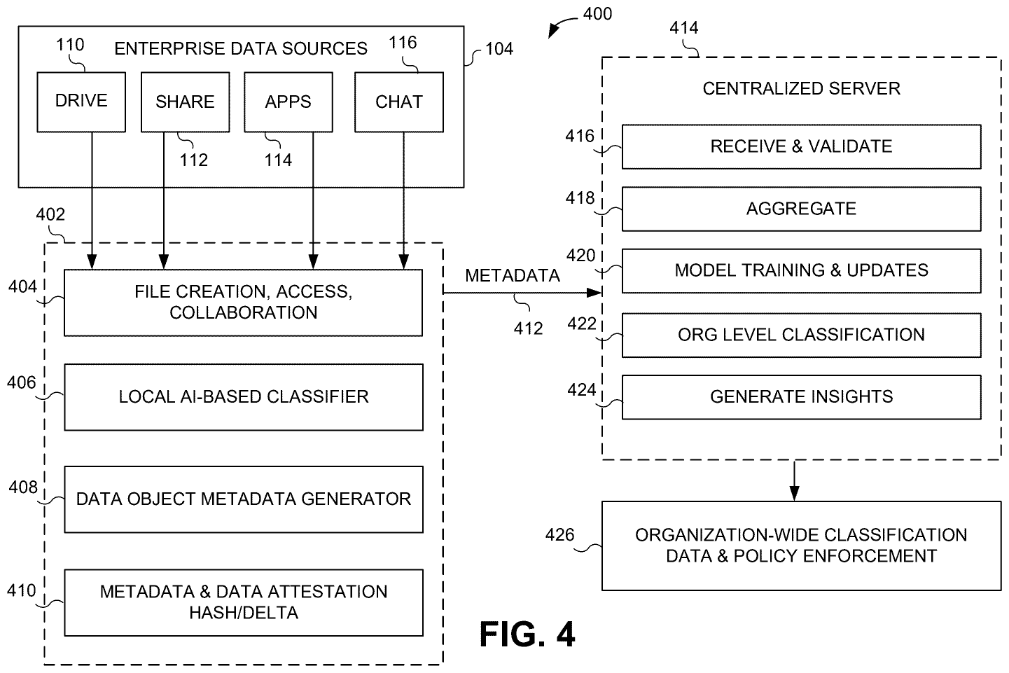

FIG. 4 shows another exemplary system architecture diagram 400 consistent with various aspects. As noted above in connection with FIG. 1, enterprise data sources 104 may be provided including drive 110, share 112, apps 114, and chat 116. The enterprise data sources and associated information protection indicia may be associated with information protection labels and associated data object classifications to control access to certain data objects. Such classifications are used to control access to sensitive information and to prevent data breaches and unauthorized access. Information protection labels help organizations safeguard their sensitive information and comply with relevant regulations.

Within endpoint computing device 402, data object classification systems consistent with various aspects may provide file creation, access, and collaboration facility 404. In these aspects, a data object classification process may be triggered in connection with file creation, access, and collaboration facility 404 making a determination that a data object (in this case a file) is being interacted with by a user of an endpoint computing device. Based on this determination, local artificial intelligence-based classifier 406 may involve behavioral analysis by employing machine learning to analyze user behavior and detect additional features associated with a user's interaction with data objects to update a machine learning model that is local to an endpoint computing device. Use of such techniques based on actual enterprise information as the enterprise information is actually being interacted with by a user of the endpoint computing device provides further information regarding such additional features and or/metadata, which can be used to update the local endpoint machine learning model accordingly.

In order to preserve endpoint computing device privacy, data object metadata generator 408 generates anonymized metadata regarding data objects associated with each local endpoint computing device, so that information regarding updates to the local endpoint machine learning model may be shared centrally without disclosure of confidential or proprietary information that is contained on the endpoint computing devices. Finally, metadata and associated data attestation with hashes and delta(s) 410 may be produced on the basis of outputs from data object metadata generator 408, so that authenticity of local endpoint computing device data can be ensured while preserving privacy and confidentiality. Such metadata 412 may be transmitted to centralized server 414 which may perform several tasks in the process of generating organization-wide classification models as well as producing rules and policies for policy enforcement (in connection with facility 426).

These tasks may include receiving and validating metadata (task 416). Metadata may be validated on the basis of associated hashes and deltas as set forth above to ensure authenticity, privacy, and confidentiality. Next, task 418 may aggregate the anonymized metadata from multiple local edge computing devices, so that the aggregated metadata may be used to update a centralized machine learning model and associated policies, such that additional features identified on one endpoint computing device may potentially be shared with other similarly situated endpoint computing devices that are part of the same or similar organization. In some aspects, the anonymized metadata may employ delta hashing to increase performance and provide a technical enhancement to functioning of computer technology associated with the endpoint devices. In some such aspects, artificial intelligence optimized processors such as graphics processing units or neural processing units may process the delta hashes in parallel, which delta hashes represent a more compact amount of data to be processed, thereby improving the operation of computing resources associated with the endpoint devices. The model updates are performed at task 420, which involves both the training of a centralized machine learning model with the anonymized metadata, but also validating the re-trained models with pre-labeled validation data objects such that updates from particular endpoint computing devices may be disregarded if they do not contribute to the overall improvement of the centralized machine learning model. This further training and validation may also facilitate organizational-level classification (task 422) which enables data objects to receive classifications at centralized level of the overall organization. Finally, at task 424 insights may be generated on the basis of the aggregated, anonymized metadata from each reporting endpoint computing device and pushed back out to the respective endpoint devices.

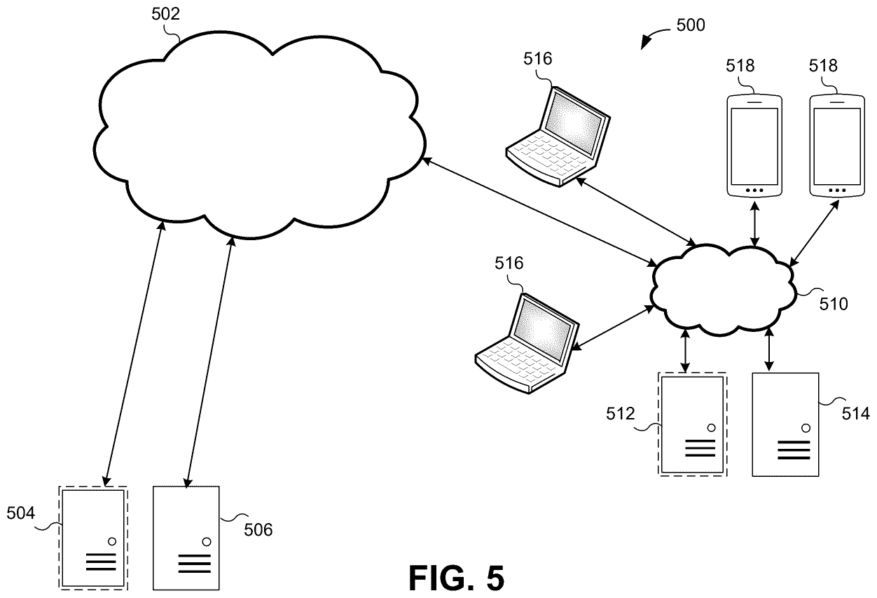

FIG. 5 shows another exemplary system architecture diagram 500 consistent with various aspects including centralized policy updates as well as platform operator updates. In system architecture diagram 500, a public Internet 502 may provide connectivity to virtual server 504 and physical server 506 which represent computing resources of a classification platform provider which may provide software systems that enable classification systems according to various aspects described herein. Servers 504 and 506 may provide software and associated updates as well as software-as-a-service functionality to an organization hosting organizational computing resources in connection with intranet 510.

Intranet 510 may be any kind of an organizational network through which electrical signals may be sent, which network may be connected directly or indirectly to public Internet 502 by way of any number of firewalls and proxy servers (not shown). Endpoint computing devices 516 may access organizational intranet 510 either directly or indirectly, by way of a virtual private network, for example. As illustrated endpoints 516 may be traditional endpoint computing devices, such as laptops or desktop computer systems, etc. Mobile endpoint computing devices 518 may be smartphones, tablets or the like and similarly may access organizational intranet 510. Virtual server 512 and physical server 514 may be operated on premises associated with the hosting organization which is providing enterprise data object classification services to endpoint devices 516 and 518. Servers 512 and 514 may provide functionality of receiving anonymized metadata from endpoint devices 516 and 518 as described above.

Unless explicitly specified, the term “transmit” encompasses both direct (point-to-point) and indirect transmission (via one or more intermediary points). Similarly, the term “receive” encompasses both direct and indirect reception.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “at least one” and “one or more” may be understood to include any integer number greater than or equal to one, i.e., one, two, three, four, [ . . . ], etc. The term “a plurality” or “a multiplicity” may be understood to include any integer number greater than or equal to two, i.e., two, three, four, five, [ . . . ], etc. The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The terms “processor” as used herein may be understood as any kind of technological entity that allows handling of data. The data may be handled according to one or more specific functions that the processor execute. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital

Signal Processor (DSP), Field Programmable Gate Array (FPGA), integrated circuit, Application Specific Integrated Circuit (ASIC), etc., or any combination thereof. Any other kind of implementation of the respective functions may also be understood as a processor. It is understood that any two (or more) of the processors detailed herein may be realized as a single entity with equivalent functionality or the like, and conversely that any single processor detailed herein may be realized as two (or more) separate entities with equivalent functionality or the like.

The following examples pertain to aspects of the configuration proposed herein.

Example 1 is an apparatus. The apparatus includes a memory, and a processor, configured to: determine, at an endpoint device, a classification of a data object based on output from a machine learning model configured to take as input contents and metadata of the data object, wherein the classification includes a confidence score; determine that the data object requires additional review, based on the confidence score; compute a data object hash based on the contents and the metadata of the data object; and update an internal structure of the machine learning model based on the additional review, the data object hash, and subsequent operation of the endpoint device.

In Example 2, the subject matter of Example 1 can optionally include that the data object hash includes a hash value and a hash delta.

In Example 3, the subject matter of either Example 1 or 2 can optionally include that the data object includes at least one of: a digital file; a binary large object; a database record; and a value associated with a key value pair.

In Example 4, the subject matter of any one of Examples 1 to 3 can optionally include that the processor is further configured to: assign the classification to the data object, based on a determination that the confidence score is within a predefined high confidence range.

In Example 5, the subject matter of any one of Examples 1 to 4 can optionally include that the processor is further configured to: generate a metadata summary including anonymized metadata and an anonymized updated structure of the machine learning model; and make the metadata summary available to a centralized metadata repository.

In Example 6, the subject matter of any one of Examples 1 to 5 can optionally include that the anonymized metadata contains at least one anonymized correspondence characteristic between the data object hash and the additional classification label.

In Example 7, the subject matter of any one of Examples 1 to 6 can optionally include that the centralized metadata repository is a centralized metadata storage associated with a centralized analytics server associated with an enterprise hosting the apparatus for use within the enterprise.

In Example 8, the subject matter of any one of Examples 1 to 7 can optionally include that the centralized metadata repository is a centralized platform analytics server associated with a platform provider providing services to an enterprise hosting the apparatus for use within the enterprise.

In Example 9, the subject matter of any one of Examples 1 to 8 can optionally include that the processor is further configured to: further update the internal structure of the machine learning model based on the classification policy update of a centralized classification policy source.

In Example 10, the subject matter of any one of Examples 1 to 9 can optionally include that the classification policy update includes at least one centrally provided structural change configured to be applied to the machine learning model.

In Example 11, the subject matter of any one of Examples 1 to 10 can optionally include that the at least one centrally provided structural change includes at least one anonymized external characteristic defining an external correspondence between an external data object hash and an external classification label.

In Example 12, the subject matter of any one of Examples 1 to 11 can optionally include that the centralized classification policy transmitter is the centralized metadata repository.

In Example 13, the subject matter of any one of Examples 1 to 12 can optionally include that the centralized classification policy transmitter is the centralized metadata repository.

In Example 14, the subject matter of any one of Examples 1 to 13 can optionally include that the processor is further configured to: determine a second classification based on application of the updated machine learning model to second contents and second metadata of a second data object; and prohibit an operation on the second data object.

In Example 15, the subject matter of any one of Examples 1 to 14 can optionally include that the processor is further configured to: determine a second classification based on application of the updated machine learning model to second contents and second metadata of a second data object; and allow an operation on the second data object.

In Example 16, the subject matter of any one of Examples 1 to 15 can optionally include that the operation is an exfiltration operation.

In Example 17, the subject matter of any one of Examples 1 to 16 can optionally include that the operation is an access operation.

Example 18 is an apparatus. The apparatus includes: a memory; and a processor, configured to: determine a subset of metadata summaries from a plurality of metadata summaries for aggregation based on correlations in the subset of metadata summaries; aggregate the subset of metadata summaries based on the correlations; train a centralized machine learning model based on the aggregated subset of metadata summaries; derive a plurality of pattern-based policies from the centralized machine learning model and the aggregated subset of metadata summaries; generate an endpoint update for machine learning models in the plurality of endpoint devices, based on the pattern-based policies; and transmit the endpoint update to the plurality of endpoint devices.

In Example 19, the subject matter of Examples 18 can optionally include that the plurality of data object classification metadata summaries is anonymized.

In Example 20, the subject matter of either of Examples 18 or 19 can optionally include that the processor is further configured to: validate the subset of the plurality of metadata summaries based on a plurality of pre-categorized data objects.

In Example 21, the subject matter of either of Examples 18 to 20, can optionally include that the processor is further configured to: perform centralized inference testing based on a plurality of pre-classified data objects.

In Example 22, the subject matter of either of Examples 18 to 21, can optionally include that the processor is configured to aggregate the subset of metadata summaries further includes the processor configured to correlate metadata summaries within the subset of metadata summaries based on at least one user behavior pattern associated with the correlated metadata summaries.

In Example 22, the subject matter of either of Examples 18 to 22, can optionally include that the processor is further configured to: generate organizational reports based on the derived insights.

In Example 22, the subject matter of either of Examples 18 to 23, can optionally include that the processor is further configured to: generate compliance and/or audit reports based on determining adherence to the pattern-based policies.

Example 25 is a non-transitory computer readable medium. The non-transitory computer readable medium includes instructions which, when executed by a processor, implement: determining, at an endpoint device, a classification of a data object based on output from a machine learning model configured to take as input contents and metadata of the data object, wherein the classification includes a confidence score; determining that the data object requires additional review, based on the confidence score and at least one additional feature of the data object; computing a data object hash based on the contents and the metadata of the data object; and updating an internal structure of the machine learning model based on the additional review, the data object hash, and the at least one additional feature of the data object of the endpoint device.

In Example 26, the subject matter of Example 25, can optionally include that the data object hash includes a hash value and a hash delta.

In Example 27, the subject matter of either of Examples 26 or 26, can optionally include that the data object includes at least one of: a digital file; a binary large object; a database record; and a value associated with a key value pair.

In Example 28, the subject matter of any one of Examples 25 to 27, can optionally include that the instructions further include: assigning the classification to the data object, based on a determination that the confidence score is within a predefined high confidence range.

In Example 29, the subject matter of any one of Examples 25 to 28, can optionally include that the instructions further include: generating a metadata summary including anonymized metadata and an anonymized updated structure of the machine learning model; and making the metadata summary available to a centralized metadata repository.

In Example 30, the subject matter of any one of Examples 25 to 29, can optionally include that the anonymized metadata contains at least one anonymized correspondence characteristic between the data object hash and the additional classification label.

In Example 31, the subject matter of any one of Examples 25 to 30, can optionally include that the centralized metadata repository is a centralized metadata storage associated with a centralized analytics server associated with an enterprise hosting the apparatus for use within the enterprise.

In Example 32, the subject matter of any one of Examples 25 to 31, can optionally include that the centralized metadata repository is a centralized platform analytics server associated with a platform provider providing services to an enterprise hosting the apparatus for use within the enterprise.

In Example 33, the subject matter of any one of Examples 25 to 32, can optionally include that the instructions further include: generating a centrally updated machine learning model based on an update of the internal structure of the machine learning model based on the classification policy update of a centralized classification policy source; computing an update score for the classification policy update based on a comparison of a data object classification of a previously-classified data object using both the machine learning model and the centrally updated machine learning model; providing the centralized classification policy source access to the update score; and rejecting the classification policy update, based on a determination that the update score is outside of a predefined range.

In Example 34, the subject matter of any one of Examples 25 to 33, can optionally include that the classification policy update includes at least one centrally provided structural change configured to be applied to the machine learning model.

In Example 35, the subject matter of any one of Examples 34, can optionally include that the at least one centrally provided structural change includes at least one anonymized external characteristic defining an external correspondence between an external data object hash and an external classification label.

In Example 36, the subject matter of any one of Examples 25 to 35, can optionally include that the centralized classification policy transmitter is the centralized metadata repository.

In Example 37, the subject matter of any one of Examples 25 to 36, can optionally include that the centralized classification policy transmitter is the centralized metadata repository.

In Example 38, the subject matter of any one of Examples 25 to 37, can optionally include that the instructions further include: determining a second classification based on application of the updated machine learning model to second contents and second metadata of a second data object; and prohibiting an operation on the second data object.

In Example 39, the subject matter of any one of Examples 25 to 38, can optionally include that the instructions further include: determining a second classification based on application of the updated machine learning model to second contents and second metadata of a second data object; and allowing an operation on the second data object.

In Example 40, the subject matter of any one of Examples 25 to 39, can optionally include that the operation is an exfiltration operation.

In Example 41, the subject matter of any one of Examples 25 to 40, can optionally include that the operation is an access operation.

Example 42 is a non-transitory computer readable medium. The non-transitory computer readable medium includes instructions which, when executed by a processor, implement: determining a subset of metadata summaries from a plurality of metadata summaries for aggregation based on correlations in the subset of metadata summaries; aggregating the subset of metadata summaries based on the correlations; training a centralized machine learning model based on the aggregated subset of metadata summaries; deriving a plurality of pattern-based policies from the centralized machine learning model and the aggregated subset of metadata summaries; generating an endpoint update for machine learning models in the plurality of endpoint devices, based on the pattern-based policies; and transmitting the endpoint update to the plurality of endpoint devices.

In Example 43, the subject matter of Example 42, can optionally include that the plurality of data object classification metadata summaries is anonymized.

In Example 44, the subject matter of any one of Examples 42 or 43, can optionally include that the processor is further configured to: validate the subset of the plurality of metadata summaries based on a plurality of pre-categorized data objects.

In Example 45, the subject matter of any one of Examples 42 to 44, can optionally include that the processor is further configured to: perform centralized inference testing based on a plurality of pre-classified data objects.

In Example 46, the subject matter of any one of Examples 42 to 45, can optionally include that the processor configured to aggregate the subset of metadata summaries further includes the processor configured to correlate metadata summaries within the subset of metadata summaries based on at least one user behavior pattern associated with the correlated metadata summaries.

In Example 47, the subject matter of any one of Examples 42 to 46, can optionally include that the processor is further configured to: generate organizational reports based on the derived insights.

In Example 48, the subject matter of any one of Examples 42 to 47, can optionally include that the processor is further configured to: generate compliance and/or audit reports based on determining adherence to the pattern-based policies.

Example 49 is a method. The method includes: determining, at an endpoint device, a classification of a data object based on output from a machine learning model configured to take as input contents and metadata of the data object, wherein the classification includes a confidence score; determining that the data object requires additional review, based on the confidence score and at least one additional feature of the data object; computing a data object hash based on the contents and the metadata of the data object; and updating an internal structure of the machine learning model based on the additional review, the data object hash, and the at least one additional feature of the data object of the endpoint device.

In Example 50, the subject matter of Example 49, can optionally include that the data object hash includes a hash value and a hash delta.

In Example 51, the subject matter of either of Examples 49 or 50, can optionally include that the data object includes at least one of: a digital file; a binary large object; a database record; and a value associated with a key value pair.

In Example 52, the subject matter of any one of Examples 49 to 51 can optionally include assigning the classification to the data object, based on a determination that the confidence score is within a predefined high confidence range.

In Example 53, the subject matter of any one of Examples 49 to 52 can optionally include generating a metadata summary including anonymized metadata and an anonymized updated structure of the machine learning model; and making the metadata summary available to a centralized metadata repository.

In Example 54, the subject matter of any one of Examples 49 to 53, can optionally include that the anonymized metadata contains at least one anonymized correspondence characteristic between the data object hash and the additional classification label.

In Example 55, the subject matter of any one of Examples 49 to 54, can optionally include that the centralized metadata repository is a centralized metadata storage associated with a centralized analytics server associated with an enterprise hosting the apparatus for use within the enterprise.

In Example 56, the subject matter of any one of Examples 49 to 55, can optionally include that the centralized metadata repository is a centralized platform analytics server associated with a platform provider providing services to an enterprise hosting the apparatus for use within the enterprise.

In Example 57, the subject matter of any one of Examples 49 to 56 can optionally include generating a centrally updated machine learning model based on an update of the internal structure of the machine learning model based on the classification policy update of a centralized classification policy source; computing an update score for the classification policy update based on a comparison of a data object classification of a previously-classified data object using both the machine learning model and the centrally updated machine learning model; providing the centralized classification policy source access to the update score; and rejecting the classification policy update, based on a determination that the update score is outside of a predefined range.

In Example 58, the subject matter of any one of Examples 49 to 57, can optionally include that the classification policy update includes at least one centrally provided structural change configured to be applied to the machine learning model.

In Example 59, the subject matter of any one of Examples 58, can optionally include that the at least one centrally provided structural change includes at least one anonymized external characteristic defining an external correspondence between an external data object hash and an external classification label.

In Example 60, the subject matter of any one of Examples 49 to 59, can optionally include that the centralized classification policy transmitter is the centralized metadata repository.

In Example 61, the subject matter of any one of Examples 49 to 60, can optionally include that the centralized classification policy transmitter is the centralized metadata repository.

In Example 62, the subject matter of any one of Examples 49 to 61, can optionally include that the processor is further configured to: determine a second classification based on application of the updated machine learning model to second contents and second metadata of a second data object; and prohibit an operation on the second data object.

In Example 63, the subject matter of any one of Examples 49 to 62, can optionally include that the processor is further configured to: determine a second classification based on application of the updated machine learning model to second contents and second metadata of a second data object; and allow an operation on the second data object.

In Example 64, the subject matter of any one of Examples 49 to 63, can optionally include that the operation is an exfiltration operation.

In Example 65, the subject matter of any one of Examples 49 to 64, can optionally include that the operation is an access operation.

Example 66 is a method. The method includes instructions which, when executed by a processor, implement: determining a subset of metadata summaries from a plurality of metadata summaries for aggregation based on correlations in the subset of metadata summaries; aggregating the subset of metadata summaries based on the correlations; training a centralized machine learning model based on the aggregated subset of metadata summaries; deriving a plurality of pattern-based policies from the centralized machine learning model and the aggregated subset of metadata summaries; generating an endpoint update for machine learning models in the plurality of endpoint devices, based on the pattern-based policies; and transmitting the endpoint update to the plurality of endpoint devices.

In Example 67, the subject matter of Example 66, can optionally include that the plurality of data object classification metadata summaries is anonymized.

In Example 68, the subject matter of any one of Examples 66 or 67 can optionally include validating the subset of the plurality of metadata summaries based on a plurality of pre-categorized data objects.

In Example 69, the subject matter of any one of Examples 66 to 68 can optionally include performing centralized inference testing based on a plurality of pre-classified data objects.

In Example 70, the subject matter of any one of Examples 66 to 69, can optionally include that the processor is configured to aggregate the subset of metadata summaries further includes the processor configured to correlate metadata summaries within the subset of metadata summaries based on at least one user behavior pattern associated with the correlated metadata summaries.

In Example 71, the subject matter of any one of Examples 66 to 70 can optionally include generating organizational reports based on the derived insights.

In Example 72, the subject matter of any one of Examples 66 to 71 can optionally include generating compliance and/or audit reports based on determining adherence to the pattern-based policies.

Example 73 is a document classification system. The document classification system includes: an endpoint processor for determining, at an endpoint device, a classification of a data object based on output from a machine learning model configured to take as input contents and metadata of the data object, wherein the classification includes a confidence score; a review user interface for determining that the data object requires additional review, based on the confidence score and at least one additional feature of the data object; a hash generator for computing a data object hash based on the contents and the metadata of the data object; and an artificial intelligence processor for updating an internal structure of the machine learning model based on the additional review, the data object hash, and the at least one additional feature of the data object of the endpoint device.

In Example 74, the subject matter of Example 73, can optionally include that the data object hash includes a hash value and a hash delta.

In Example 75, the subject matter of either of Examples 73 or 74, can optionally include that the data object includes at least one of: a digital file; a binary large object; a database record; and a value associated with a key value pair.

In Example 76, the subject matter of any one of Examples 73 to 75, can optionally include that the endpoint processor is further configured to: assign the classification to the data object, based on a determination that the confidence score is within a predefined high confidence range.

In Example 77, the subject matter of any one of Examples 73 to 76, can optionally include that the endpoint processor is further configured to: generate a metadata summary including anonymized metadata and an anonymized updated structure of the machine learning model; and make the metadata summary available to a centralized metadata repository.

In Example 78, the subject matter of any one of Examples 73 to 77, can optionally include that the anonymized metadata contains at least one anonymized correspondence characteristic between the data object hash and the additional classification label.

In Example 79, the subject matter of any one of Examples 73 to 78, can optionally include that the centralized metadata repository is a centralized metadata storage associated with a centralized analytics server associated with an enterprise hosting the document classification system for use within the enterprise.

In Example 80, the subject matter of any one of Examples 73 to 79, can optionally include that the centralized metadata repository is a centralized platform analytics server associated with a platform provider providing services to an enterprise hosting the document classification system for use within the enterprise.

In Example 81, the subject matter of any one of Examples 73 to 80, can optionally include that the endpoint processor is further configured to: generate a centrally updated machine learning model based on an update of the internal structure of the machine learning model based on the classification policy update of a centralized classification policy source; compute an update score for the classification policy update based on a comparison of a data object classification of a previously-classified data object using both the machine learning model and the centrally updated machine learning model; provide the centralized classification policy source access to the update score; and reject the classification policy update, based on a determination that the update score is outside of a predefined range.

In Example 82, the subject matter of any one of Examples 73 to 81, can optionally include that the classification policy update includes at least one centrally provided structural change configured to be applied to the machine learning model.

In Example 83, the subject matter of Example 82, can optionally include that the at least one centrally provided structural change includes at least one anonymized external characteristic defining an external correspondence between an external data object hash and an external classification label.

In Example 84, the subject matter of any one of Examples 73 to 83, can optionally include that the centralized classification policy transmitter is the centralized metadata repository.

In Example 85, the subject matter of any one of Examples 73 to 84, can optionally include that the centralized classification policy transmitter is the centralized metadata repository.

In Example 86, the subject matter of any one of Examples 73 to 85, can optionally include that the processor is further configured to: determine a second classification based on application of the updated machine learning model to second contents and second metadata of a second data object; and prohibit an operation on the second data object.

In Example 87, the subject matter of any one of Examples 73 to 86, can optionally include that the processor is further configured to: determine a second classification based on application of the updated machine learning model to second contents and second metadata of a second data object; and allow an operation on the second data object.

In Example 88, the subject matter of any one of Examples 73 to 87, can optionally include that the operation is an exfiltration operation.

In Example 89, the subject matter of any one of Examples 73 to 88, can optionally include that the operation is an access operation.

Example 90 is a document classification system. The document classification system includes: a metadata summarizer for determining a subset of metadata summaries from a plurality of metadata summaries for aggregation based on correlations in the subset of metadata summaries; a metadata aggregator for aggregating the subset of metadata summaries based on the correlations; an artificial intelligence training system for training a centralized machine learning model based on the aggregated subset of metadata summaries; a pattern matching system for deriving a plurality of pattern-based policies from the centralized machine learning model and the aggregated subset of metadata summaries; an artificial intelligence model updating system generating an endpoint update for machine learning models in the plurality of endpoint devices, based on the pattern-based policies; and a network interface for transmitting the endpoint update to the plurality of endpoint devices.

In Example 91, the subject matter of any one of Examples 90, can optionally include that the plurality of data object classification metadata summaries is anonymized.

In Example 92, the subject matter of any one of Examples 90 or 91 can optionally include a summary validator for validating the subset of the plurality of metadata summaries based on a plurality of pre-categorized data objects.

In Example 93, the subject matter of any one of Examples 90 to 92 can optionally include a centralized inference tester for performing centralized inference testing based on a plurality of pre-classified data objects.

In Example 94, the subject matter of any one of Examples 90 to 93, can optionally include that the metadata aggregator correlates metadata summaries within the subset of metadata summaries based on at least one user behavior pattern associated with the correlated metadata summaries.

In Example 95, the subject matter of any one of Examples 90 to 94, can optionally include a report generator for generating organizational reports based on the derived insights.

In Example 96, the subject matter of any one of Examples 95, can optionally include that the report generator is further configured to generate compliance and/or audit reports based on determining adherence to the pattern-based policies.

What is claimed is:

1. An apparatus comprising:
a memory; and
a processor, configured to:
determine, at an endpoint device, a classification of a data object based on output from a machine learning model configured to take as input contents and metadata of the data object, wherein the classification comprises a confidence score;
determine that the data object requires additional review, based on the confidence score;
compute a data object hash based on the contents and the metadata of the data object; and
update an internal structure of the machine learning model based on the additional review, the data object hash, and subsequent operation of the endpoint device.

2. The apparatus of claim 1, wherein the data object hash comprises a hash value and a hash delta.

3. The apparatus of claim 1, wherein the data object comprises at least one of:
a digital file;
a binary large object;
a database record; and
a value associated with a key value pair.

4. The apparatus of claim 1, wherein the processor is further configured to:
assign the classification to the data object, based on a determination that the confidence score is within a predefined high confidence range.

5. The apparatus of claim 1, wherein the processor is further configured to:
generate a metadata summary comprising anonymized metadata and an anonymized updated structure of the machine learning model; and
make the metadata summary available to a centralized metadata repository.

6. The apparatus of claim 1, wherein the anonymized metadata contains at least one anonymized correspondence characteristic between the data object hash and the additional classification label.

7. The apparatus of claim 1, wherein the centralized metadata repository is a centralized metadata storage associated with a centralized analytics server associated with an enterprise hosting the apparatus for use within the enterprise.

8. The apparatus of claim 1, wherein the centralized metadata repository is a centralized platform analytics server associated with a platform provider providing services to an enterprise hosting the apparatus for use within the enterprise.

9. The apparatus of claim 1, wherein the processor is further configured to:
further update the internal structure of the machine learning model based on the classification policy update of a centralized classification policy source.

10. The apparatus of claim 1, wherein the classification policy update comprises at least one centrally provided structural change configured to be applied to the machine learning model.

11. The apparatus of claim 10, wherein the at least one centrally provided structural change comprises at least one anonymized external characteristic defining an external correspondence between an external data object hash and an external classification label.

12. The apparatus of claim 1, wherein the centralized classification policy transmitter is the centralized metadata repository.

13. The apparatus of claim 1, wherein the centralized classification policy transmitter is the centralized metadata repository.

14. The apparatus of claim 1, wherein the processor is further configured to:
determine a second classification based on application of the updated machine learning model to second contents and second metadata of a second data object; and
prohibit an operation on the second data object.

15. The apparatus of any one of claim 1, wherein the processor is further configured to:
determine a second classification based on application of the updated machine learning model to second contents and second metadata of a second data object; and
allow an operation on the second data object.

16. The apparatus of claim 1, wherein the operation is an exfiltration operation.

17. The apparatus of claim 1, wherein the operation is an access operation.

18. An apparatus comprising:
a memory; and
a processor, configured to:
determine a subset of metadata summaries from a plurality of metadata summaries for aggregation based on correlations in the subset of metadata summaries;
aggregate the subset of metadata summaries based on the correlations;
train a centralized machine learning model based on the aggregated subset of metadata summaries;
derive a plurality of pattern-based policies from the centralized machine learning model and the aggregated subset of metadata summaries;
generate an endpoint update for machine learning models in the plurality of endpoint devices, based on the pattern-based policies; and
transmit the endpoint update to the plurality of endpoint devices.

19. The apparatus of claim 18, wherein the plurality of data object classification metadata summaries is anonymized.

20. The apparatus of claim 18, wherein the processor is further configured to:
validate the subset of the plurality of metadata summaries based on a plurality of pre-categorized data objects.
